(19) United States
(12) Patent Application Publication
(10) Pub. No.: US 2016/0311489 A1
(43) Pub. Date: Oct. 27, 2016

(54) BICYCLE FENDER

(71) Applicant: Cho-Ten Chiu, New Taipei (TW)

(72) Inventor: Cho-Ten Chiu, New Taipei (TW)

(21) Appl. No.: 14/692,783

(22) Filed: Apr. 22, 2015

(51) Int. Cl. B62J 23/00

(52) U.S. Cl. CPC B62J 23/00

(57) ABSTRACT

The fender includes a board body, an aluminum sheet and an embedding board. The board body is made of plastic and has a trough. The aluminum sheet is disposed on a bottom of the trough. The embedding board is embedded in the trough on the aluminum sheet and made of a translucent material.

### BACKGROUND OF THE INVENTION

1. Technical Field

The invention relates to bicycles, particularly to structure of fenders.

2. Related Art

A primary purpose of a fender is to prevent sand, mud, rocks, liquids, and other road spray from being thrown into the air by the rotating tire.

Usually, bicycle fenders are made of a single plastic or metal material, so they appear quiet and monotonous. No pattern or symbol can be added on surfaces of the fenders to enhance cosmetic appearance. In order to improve appearance of fenders or mark logos, manufacturers usually use stickers to attach on fenders. However, attaching stickers must completely rely upon manual operation. Not only can fast mass production be accomplished, but also the quality of attaching stickers cannot be uniform. For example, a polygonal sticker is very different to be smoothly attached on a fender. Thus, such stickers usually are designed in a relatively small size. Furthermore, the stickers on fenders will peel off the fenders because of natural deterioration of viscidity.

### SUMMARY OF THE INVENTION

An object of the invention is to provide a bicycle fender, which can improve cosmetic appearance without stickers.

Another object of the invention is to provide a bicycle fender, which can improve production efficiency without manual operations.

Still another object of the invention is to provide a bicycle fender, which can show a pattern or logo in the fender.

To accomplish the above objects, the fender of the invention includes a board body, an aluminum sheet and an embedding board. The board body is made of plastic and has a trough. The aluminum sheet is disposed on a bottom of the trough. The embedding board is embedded in the trough on the aluminum sheet and made of a translucent material.

### BRIEF DESCRIPTION OF THE DRAWINGS

FIG. 1 is an exploded view of the invention;

FIG. 2 is an assembled view of the invention;

FIG. 3 is an exploded view of the first embodiment of the invention;

FIG. 4 is an assembled view of the first embodiment of the invention;

FIG. 5 is an exploded view of the second embodiment of the invention;

FIG. 6 is an assembled view of the second embodiment of the invention;

FIG. 7 is an exploded view of the third embodiment of the invention; and

FIG. 8 is an assembled view of the third embodiment of the invention.

### DETAILED DESCRIPTION OF THE INVENTION

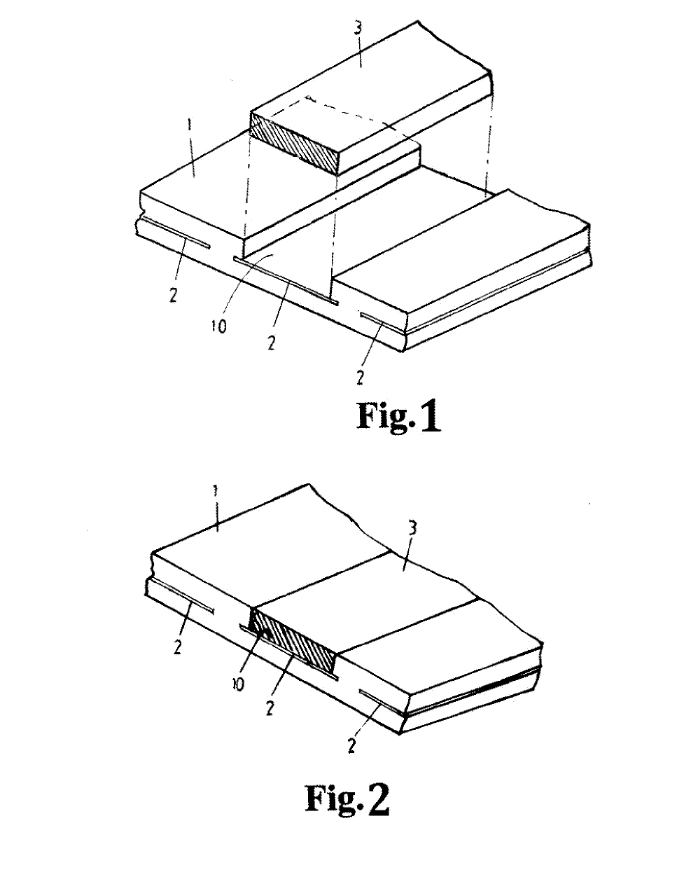

Please refer to FIGS. 1 and 2. The fender of the invention primarily includes a board body 1 with a plurality of aluminum sheets 2. The aluminum sheets 2 are embedded in the board body 1. The board body 1 is formed with a trough 10. One of the aluminum sheets 2 is fastened on the bottom of the trough 10. An embedding board 3 is firmly embedded in the trough 10 and on the aluminum sheet 2 in the trough 10. And the embedding board 3 is made of a translucent material with or without a color, which is different the board body 1. Thus the fender can show at least two colors by the board body 1 and the embedding board 3. This can improve production quality and cosmetic appearance of the fender.

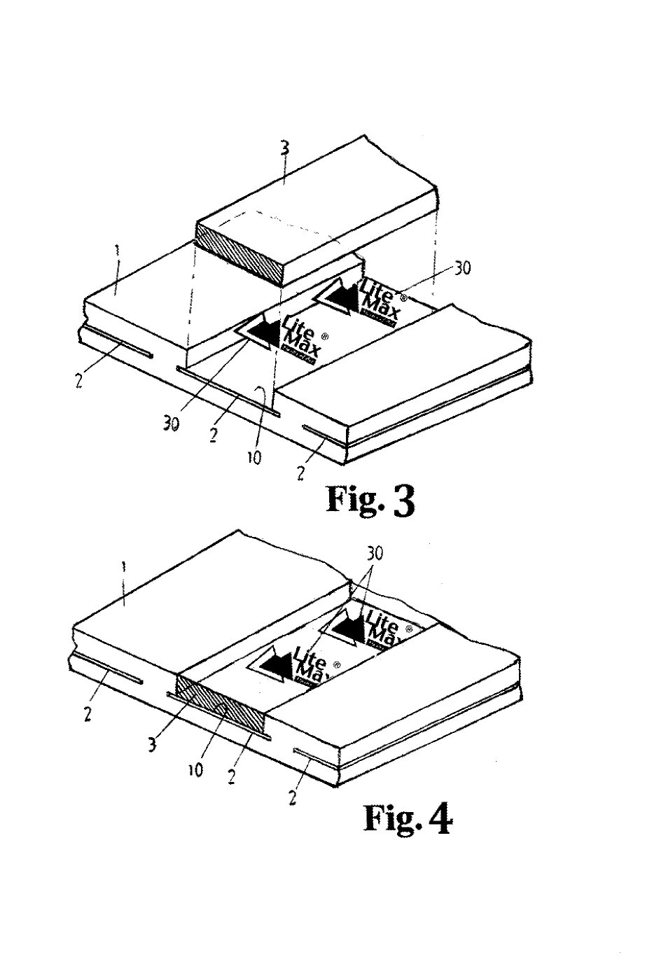

Please refer to FIGS. 3 and 4, which show the first embodiment of the invention. As shown, the embedding board 3 can be formed with a pattern or logo 30. Because the embedding board 3 is made of a translucent material, the pattern or logo 30 on the embedding board 3 is visible.

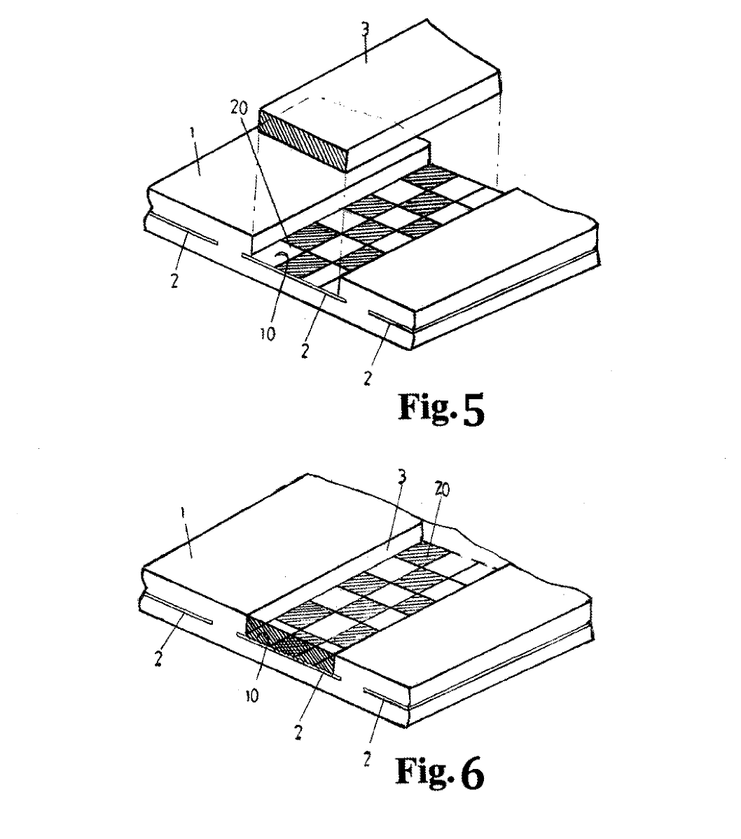

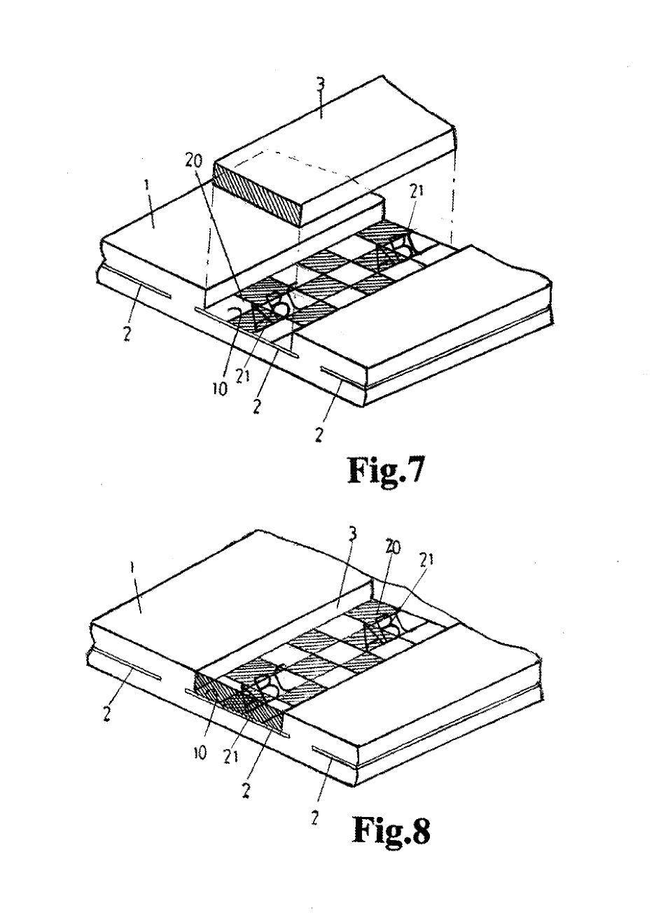

Alternatively, the pattern or logo 30 may be formed on the aluminum sheet 2 under the embedding board 3. Because the embedding board 3 is translucent, the pattern or logo 30 on the aluminum sheet 2 is visible. Please refer to FIGS. 5 and 6, which show the second embodiment of the invention. In these embodiments, a pattern 20 is formed on the aluminum sheet 2 under the embedding board 3. The pattern 20 may be added with a logo 21 as shown in FIGS. 7 and 8.

It will be appreciated by persons skilled in the art that the above embodiment has been described by way of example only and not in any limitative sense, and that various alterations and modifications are possible without departure from the scope of the invention as defined by the appended claims.

What is claimed is:

1. A fender for a bicycle, comprising:
a board body, made of plastic, and having a trough;
an aluminum sheet, disposed on a bottom of the trough; and
an embedding board, embedded in the trough and on the aluminum sheet, and made of a translucent material.

2. The fender of claim 1, wherein the aluminum sheet is formed with a pattern.

3. The fender of claim 1, wherein the embedding board is formed with a pattern.

4. The fender of claim 1, further comprising other aluminum sheets embedded in the board body.
